(19) United States
(12) Patent Application Publication
(10) Pub. No.: US 2022/0245660 A1
(43) Pub. Date: Aug. 4, 2022

(54) PAYMENT SYSTEM AND PAYMENT METHOD, WHICH USE DISCOUNT COUPON CAPABLE OF CHANGING DISCOUNT RATE

(71) Applicant: So Young CHO, Seoul (KR)

(72) Inventor: So Young CHO, Seoul (KR)

(21) Appl. No.: 17/622,905

(22) PCT Filed: Jun. 18, 2020
(86) PCT No.: PCT/KR2020/007871

§ 371 Date: Dec. 27, 2021

(30) Foreign Application Priority Data
Jul. 4, 2019 (KR) 10-2019-0080908

(51) Int. Cl. G06Q 30/02; G06Q 20/38

(52) U.S. Cl. CPC G06Q 30/0212; G06Q 20/387; G06Q 30/0239

(57) ABSTRACT

The present invention discloses a payment system and method providing an opportunity to change a basic discount range of a coupon upon a customer request, thereby inducing active participation of the customer. The payment system using a discount coupon capable of changing a discount range, comprising: a web server generating first coupon information in which a discount range is changed according to a coupon change request signal received through a web page and transmitting the first coupon information through the web page; and a plurality of user terminals transmitting the coupon change request signal to the web server when a touch signal of a coupon change menu of the web page is inputted, and receiving and outputting the first coupon information. The present invention can induce interest to customers, stimulate them to have expectation for shopping, and increase the number of visiting on website and application, by providing several opportunities to change discount range of coupons upon customers' requests.

### FIELD OF THE INVENTION

The present invention relates to payment systems and methods using discount coupons providing opportunities to change discount ranges, and more specifically, to payment systems and methods inducing customers to use coupons by providing opportunities that can change basic discount ranges of coupons upon customer requests.

### BACKGROUND OF THE INVENTION

Recently, electronic commercial transactions are commonly used according to development of the internet and communication technologies. The electronic commercial transaction refers to all types of transactions of buying and selling of goods or services using the internet.

In conventional e-commerce shopping malls, customers decide their purchase based on the predetermined price, which refers to static pricing. When transactions are performed under the static pricing, customers check product price, visiting a large number of e-commerce websites, or compare the price for the same product in price comparison websites. Accordingly, this type of transaction causes customers to spend a lot of time on shopping and cannot induce interest to customers.

To solve the problem, a transaction method in a form of auction has been suggested as an initial stage of dynamic pricing. In addition, a transaction method, in which customers can bargain with sellers for the price through online, has been proposed.

However, these conventional transaction methods have problems that purchasers or sellers need to reconnect to corresponding websites or discontinuously participate in the transaction, presenting desired condition through e-mail or the like, and thus a lot of time is required for the transaction. This also cannot induce interest to the customers, and many transactions chances are lost.

### DETAILED DESCRIPTION OF THE INVENTION

### Technical Problems

Therefore, the first object of the present invention is to provide a payment system using discount coupon that provides opportunities for customers to purchase products or use services at low price by providing discount coupons to which discount ranges higher than basic discount ranges are applied upon customer requests.

In addition, the second object of the present invention is to provide a payment method using discount coupon, which can secure sufficient members by stimulating customers' curiosity, and can induce use of discount coupons by providing opportunities to change discount ranges of discount coupons.

### SUMMARY OF THE INVENTION

To achieve the first object of the present invention, one embodiment of the present invention provides a payment system using a discount coupon that can change a discount range, the payment system comprising: a web server generating first coupon information whose discount range is changed upon a coupon change request signal received through a web page, and transmitting the first coupon information through the web page; and a plurality of user terminals transmitting the coupon change request signal to the web server when a touch signal of a coupon change menu of the web page is inputted, and receiving and outputting the first coupon information.

To achieve the second object of the present invention, one embodiment of the present invention provides a payment method using a discount coupon that can change a discount range, the payment method comprising: a first discount coupon providing step of providing, by a web server, a first discount coupon in which a basic discount range is set and a coupon change menu is included, to a user terminal accessing a web page; a change request receiving step of receiving, by the web server, a coupon change request signal generated through the coupon change menu; and a second discount coupon providing step of generating, by the web server, a second discount coupon whose discount range is changed according to the coupon change request signal, and providing the second discount coupon to the user terminal.

### TECHNICAL EFFECTS OF THE INVENTION

According to the present invention, a payment system can induce interest to customers, stimulate them to have expectation for shopping, and increase sales of products or use of services, by providing several opportunities to change discount range of coupons upon customers' requests.

In addition, the present invention can improve customer satisfaction and loyalty, by returning a part of profits to consumers.

Furthermore, the present invention can obtain additional profits through sales of mileage, acquisition of virtual currency, and advertisements in addition to commission for the product sales, by inducing customers to use mileage and virtual currency, or to view advertisement.

In addition, the present invention can increase sales of products, by providing a service that can change discount ranges of coupons and inducing customers' interest.

### BRIEF DESCRIPTION OF THE DRAWINGS

FIG. 1 is a diagram of an online connection of a payment system according to an embodiment of the present invention.

FIGS. 2 and 3 are schematic drawings illustrating one embodiment of a web page provided to a user terminal by a web server of the present invention.

FIGS. 4 and 5 are schematic drawings illustrating another embodiment of a web page provided to a user terminal by a web server of the present invention.

FIGS. 6 and 7 are schematic drawings illustrating another embodiment of a web page provided to a user terminal by a web server of the present invention.

FIG. 8 is a block diagram illustrating an embodiment of a web server according to an embodiment of the present invention.

FIG. 9 is a flowchart illustrating a payment method using a discount coupon according to an embodiment of the present invention.

FIG. 10 is a flowchart illustrating a payment method using a discount coupon according to another embodiment of the present invention.

### BEST MODE FOR THE INVENTION

Hereinafter, a payment system using a discount coupon capable of changing a discount range according to preferred embodiments of the present invention will be described in detail with reference to the accompanying drawings.

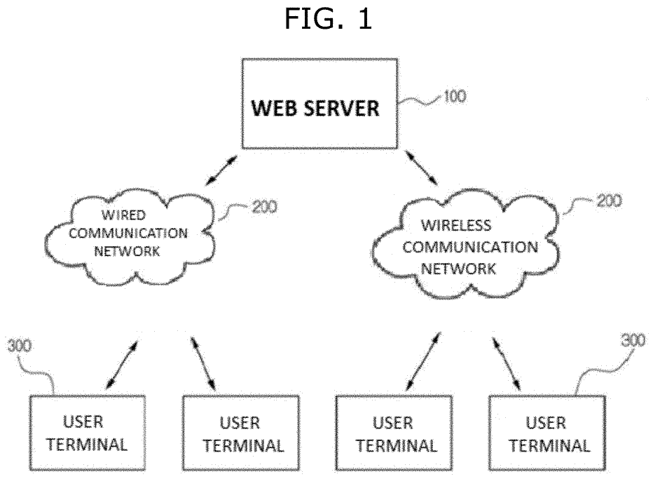

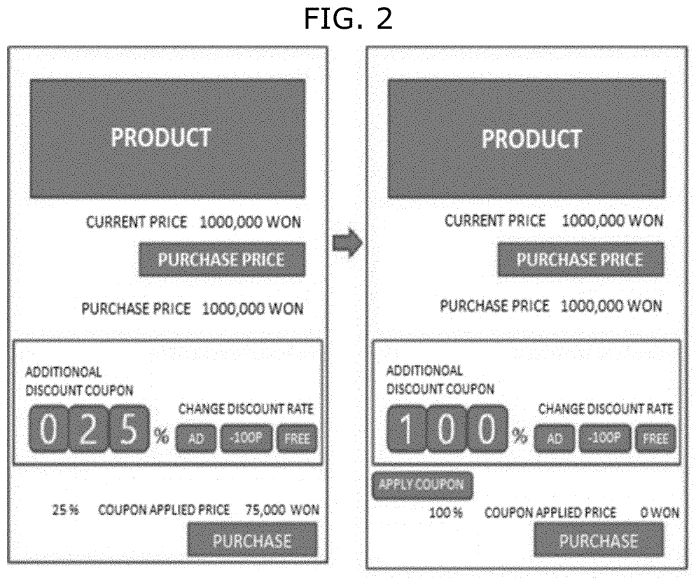

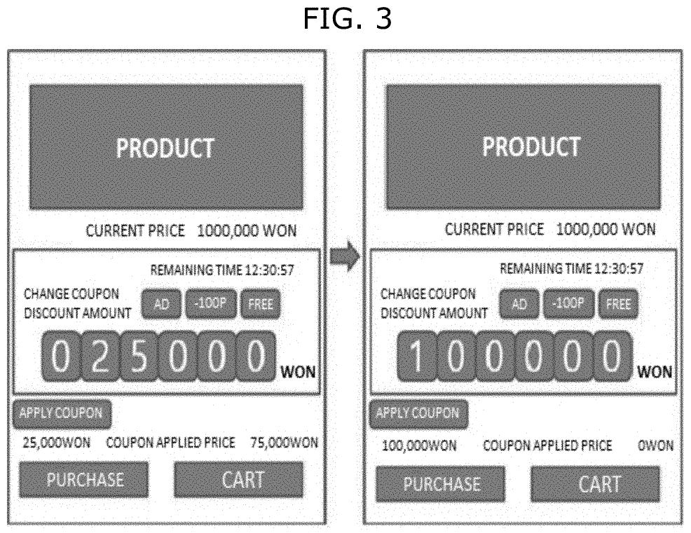

FIG. 1 is a diagram of an online connection of a payment system according to an embodiment of the present invention. FIGS. 2 and 3 are schematic drawings illustrating one embodiment of a web page provided to a user terminal by a web server of the present invention.

Referring to FIG. 1, a payment system according to the present invention comprises: a web server 100 storing and distributing electronic coupon information; and a plurality of user terminals 300 connected to the web server 100 through a network including wired and wireless communication networks hereinafter, referred to as “network”, receiving the electronic coupon information, and providing a coupon change request signal to the web server 100.

The payment system may be used in internet shopping, mobile shopping, TV home shopping, Internet Protocol Television IPTV, and the like, which sell products, and can be used in a stock trading website, an internet banking website, a parking management website, a travel ticket website, a concert ticket website, an airline ticket website, a virtual currency website, a gift certificate website, a game website, a point website, a reward website, a mileage website, a food delivery website, an accommodation website, an insurance website, a legal service website, a blockchain website, a shopping mall website, and the like.

Hereinafter, the present invention will be described in more detail with reference to the drawings.

Referring to FIG. 1, a payment system according to the present invention includes a web server 100.

The web server 100 provides sales information of a product and use information of a service to a customer through a web page provided by the web server 100, and provides an opportunity for the customer who connects to the web page to change a discount range of a coupon possessed by the customer instead of using the coupon with a predetermined discount range.

For this function, the web server 100 stores sales information of products, services, or both, generates first coupon information whose discount range is changed according to a coupon change request signal received through the web page provided by itself, and transmits the first coupon information through the web page. In other words, the web server 100 generates a first discount coupon having the first coupon information, and transmits the first discount coupon to the user terminal 300 through the web page.

In this case, the sales information is uploaded and stored in the web server 100 through an interface of the web server 100 or a seller terminal, and is searched and extracted by the web server 100 according to the request of the user terminal 300. The extracted sales information is transmitted to the corresponding user terminal 300 by the web server 100.

It is desired that the first coupon information is configured to be maintained for a predetermined time. In addition, the discount range can be a discount rate as shown in FIG. 2, or a certain amount of money as shown in FIG. 3. The discount rate and the discount amount can be selected for any one of money, virtual currency, membership point, reward, mileage, and gift certificate.

In addition, the coupon change request signal may be configured as a request signal inputted through any one of currency payment, point payment, reward payment, mileage payment, gift certificate payment, virtual currency payment, free participation, and advertisement viewing.

In addition, the electronic coupon information stored in the web server 100 has a first discount range and a jackpot discount range for a product as shown in FIGS. 2 and 3.

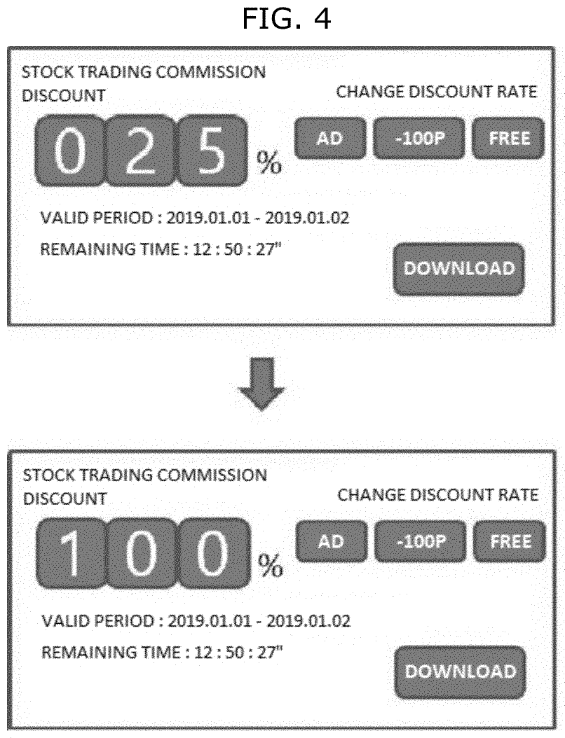

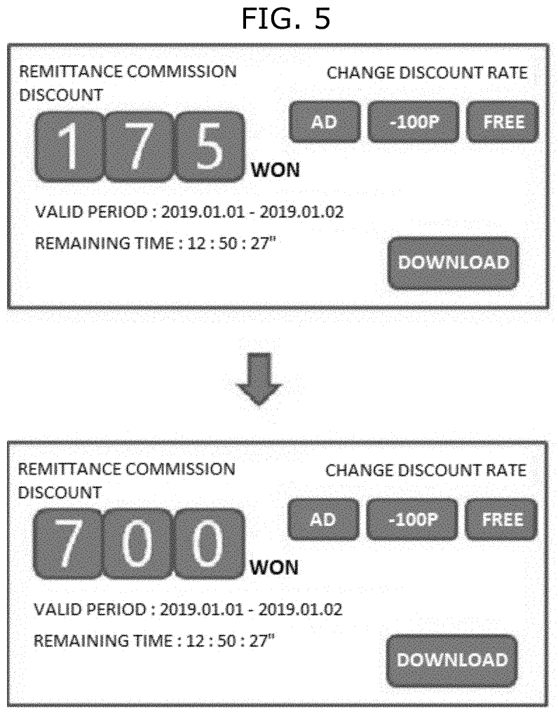

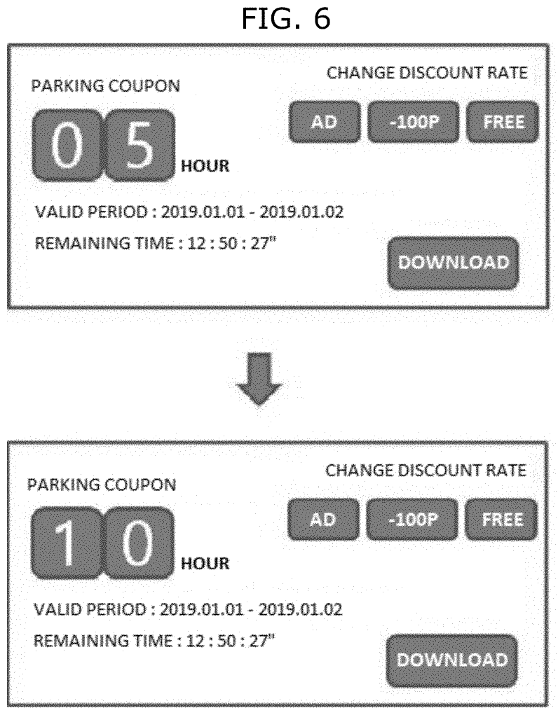

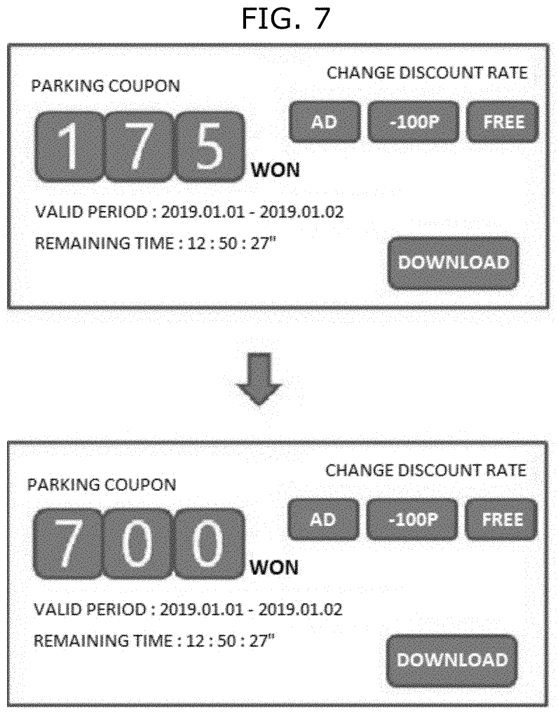

FIGS. 4 and 5 are schematic drawings illustrating another embodiment of a web page provided to a user terminal by a web server of the present invention. FIGS. 6 and 7 are schematic drawings illustrating another embodiment of a web page provided to a user terminal by a web server of the present invention.

Referring to FIGS. 4 and 5, the electronic coupon information stored in the web server 100 has the first discount range and the jackpot discount range for a service. In this case, as a discount range, a discount rate is used as shown in FIG. 4, or a certain discount amount of money is used as shown in FIG. 5, or a discount time can be used as shown in FIG. 6. In other words, a discount range can be any one of discount rate, discount amount, and discount time.

In addition, when the web server 100 receives a coupon change request signal including a change of a payment means to a virtual currency such as bitcoin, the web server 100 changes a sales price of a product and a service price of a service included in the sales information into a virtual currency unit, generates first coupon information changed in units of virtual currency, and transmits the first coupon information to the user terminal 300 which transmits the coupon change request signal through the web page.

Meanwhile, the determination of the discount range for the first discount coupon can be determined by a random discount range, which is randomly selected within a first designated discount range. In this case, the selected random discount range means a discount range repeating of irregular up and down for each time unit.

For example, the random discount range may be applied with a random down discount range and a random up discount range. More specifically, the random down discount range is overall down but performs up or down for each time unit. In addition, the random up discount range is overall up, but performs up or down for each time unit.

In a first embodiment, a web server 100 according to the present invention analyzes a profit rate of electronic commerce based on transaction information of sold products, extracts a jackpot discount range exceeding a first predetermined discount range if the profit rate exceeds a predetermined profit rate, generates second coupon information whose discount range is changed to the jackpot discount range, and transmits the second coupon information to the user terminal 300 through the web page.

For example, if the first predetermined discount range is 10% to 30%, the jackpot discount range can be determined to be a discount rate in a range from greater than 30% to 100% or less.

According to a second embodiment, the web server 100 according to the present invention analyzes an accumulated sale quantity based on transaction information of sold products, extracts a jackpot discount range exceeding a first predetermined discount range when a first coupon change request signal is received after a predetermined sale quantity is sold, generates second coupon information whose discount range is changed to the jackpot discount range, and transmits the second coupon information to the user terminal 300 transmitting the first coupon change request signal through the web page.

For example, if the first predetermined discount range is 10,000 won to 30,000 won, the jackpot discount range can be determined to be a discount amount in a range from greater than or equal to 30,000 won to less than or equal to 100,000 won.

In a third embodiment, a web server 100 according to the present invention analyzes an accumulated profit of electronic money used to generate a coupon change request signal as the coupon change request signal is received, extracts a jackpot discount range exceeding a predetermined discount range if the accumulated profits exceed a predetermined profit, generates second coupon information whose discount range is changed to the jackpot discount range, and transmits the second coupon information to the user terminal 300 which transmits the coupon change request signal through the web page.

If necessary, the web server 100 can be configured to provide a login page to the user terminal 300 connected to the web server 100 through a pop-up window provided by an affiliate website. In this case, the pop-up window includes a hyperlink connected to the login page provided by the web server 100.

When authentication information is received through the login page, the web server 100 provides the web page including a first discount coupon having a basic discount range to a corresponding user terminal 300. More specifically, the web server 100 is equipped with a web service adapter which enables the web server 100 to be connected to an affiliate website by using a unique protocol used by the affiliate website, and the web service adapter is built by using an Open API or SDK, which are provided by the affiliate website.

In addition, the web server 100 can provide one or more of first discount coupons in which a coupon use website and a basic discount range are set and a coupon change menu is included, to the user terminal 300 accessing the web page. In this case, the web server 100 exposes several discount coupons which can be used in an affiliated shopping website or a ticket sales website without exposing the sales information of the product and the use information of the service through the web page.

The web server 100 provides coupons, which can be used in various affiliate websites instead of selling a product directly, upon a user's choice.

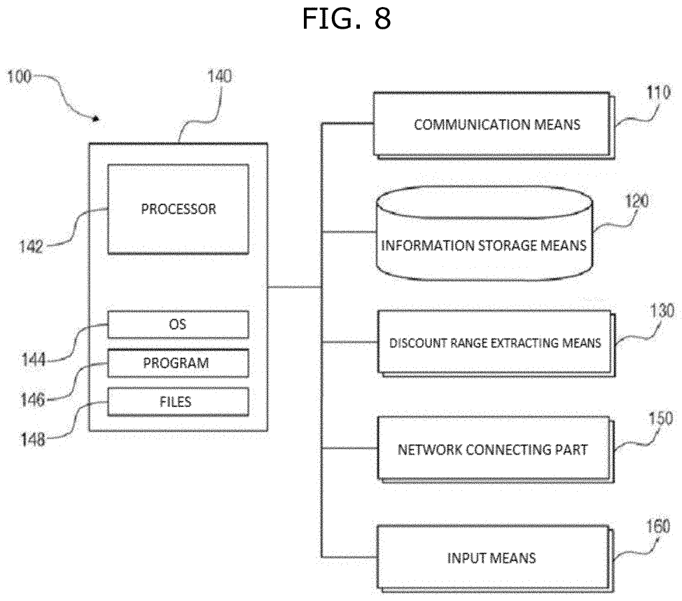

FIG. 8 is a block diagram illustrating an embodiment of a web server according to an embodiment of the present invention. Referring to FIG. 8, the web server 100 includes a communication means 110 communicating with the outside, an information storage means 120 in which sales information and purchase information of the product are classified and stored, a discount range extracting means 130 restrictedly extracting a jackpot discount range according to a profit rate of electronic commerce or an accumulated sale quantity of the product, a host part 140 controlling the overall operation of the system and calculating expected selling price of the product to which the jackpot discount is applied, and a network connecting part 150 connecting to the network 200. If necessary, the web server 100 may further include an input means 160 for a user interface.

According to the present invention, the communication means 110 of the web server 100 transmits sales information, such as sale quantity and cost of a product to a user terminal 300 through the network 200, and receives a coupon change request signal transmitted from the user terminal 300. In addition, the communication means 110 is connected to a seller terminal through the network 200 and collects sales information of a product including a cost, a total sale quantity, a maximum discount rate, a product photo, and a desired selling price from the seller terminal not shown.

According to the present invention, the information storage means 120 of the web server 100 stores sales information, purchase information, expected profit information for each product, jackpot discount information. The information storage means 120 includes a plurality of databases DB, and preferably includes a sales information DB, a purchase information DB, an expected profit DB for each product, and a discount range DB.

The sales information DB includes specific information on a seller, a product, and a service, and may include information on a cost or initial price of product or service, total sale quantity, desired sales price, maximum discount rate, product name, service name, product and service feature, product photo, an ID and password of a seller, sales information storage date, and personal information of a seller. In this case, information of each product and services stored in the sales information DB can be partially searched and viewed through the user terminal 300 registered as a member.

The purchase information DB includes a purchaser and specific information on a product and a service purchased by the purchaser. The purchase information DB may include information on a purchased product name and a service name, a transaction date of a product and a service, a coupon applied to the selling price, a sales amount paid to a seller, an ID and password of a purchaser, personal information of a purchaser, remaining sale quantity, and the like.

The expected profit DB stores a profit for each product that an operator of the web server 100 can obtain when the sale is completed.

The discount range DB stores information of a discount range, which is applied when a coupon is changed within a predetermined range set by the operator of the web server 100, and stores information of a jackpot discount range, which is applied when a coupon is changed if certain elements related to sale, such as a profit rate, a profit, and a sales amount, exceeds a predetermined level set by the operator of the web server 100. For example, if an excess profit rate of 5% to 10% is achieved, the jackpot discount range is designated as a 50% discount rate until an excess profit rate of 2% is consumed so that the amount of money corresponding to the excess profit rate of 2% is returned to the customer. When an excess profit rate of 10% to 20% is achieved, the jackpot discount range is designated as a 70% discount rate until an excess profit rate of 5% is consumed so that the amount of money corresponding to the excess profit rate of 5% is returned to the customer. In addition, when the excess profit rate of 20% to 50% is achieved, the jackpot discount range can be designated as a 100% discount rate until an excess profit rate of 10% is consumed so that the amount of money corresponding to the excess profit rate of 10% is returned to the customer. In this case, the selling price of the product becomes zero.

As such, the jackpot discount range may be selected as a discount range fixed to the coupon change request signal of the user terminal 300, and may be randomly selected within a predetermined numerical range set by the operator of the web server 100.

According to the present invention, the discount range extracting means 130 of the web server 100 analyzes the profit rate, the profit, and the sale quantity through the purchase information stored in the information storage means 120 and the expected profit DB in real time, and extracts a discount range from the discount range DB according to predetermined criteria. For example, the discount range extracting means 130 analyzes the accumulated sale quantity of the product and the service through the purchase information stored in the information storage means 120 in real time, and extracts a discount range from the discount range DB according to the predetermined number of sales times or the sales quantities.

In this case, the extraction of the jackpot range is performed for a limited number of times or a limited time. This limitation can prevent rapid degrading of the accumulated profit rate of the web server 100 operator, which may be caused when the jackpot price to which the jackpot discount range is applied is exposed to the user terminal 300 for a long time.

In some embodiments, the discount range extracting means 130 according to the present invention blocks the extraction of a jackpot discount range if a profit rate does not exceed a predetermined profit rate. In addition, the discount range extracting means 130 extracts a jackpot discount range, which is respectively set for each section of the excess profit rate, from the discount range DB if the profit rate exceeds the predetermined profit rate.

The input means 160 of the web server 100 according to the present invention is provided so that the manager of the web server 100 can directly upload sales information of a product and a service to the web server 100 without the communication means 110, and can be connected to the information storage means 120 to store the uploaded sales information. The input means 160 is preferably an input means commonly used in the art, and particularly, a keyboard or the like. However, the present invention is not limited to, and the input means 160 may be embodied with any type of input device.

According to the present invention, when the host unit 140 receives a coupon change request signal from the user terminal 300, the host unit 140 generates first coupon information, which is changed to a discount range extracted from a discount range extracting unit 130, and transmits the first coupon information to the user terminal 300 providing the coupon change request signal. The host unit 140 includes a processor 142 connected to and controlling the communication means 110, the information storage means 120, and the discount range extraction means 130 and a program 146 controlling the processor 142.

More specifically, the host unit 140 may include the processor 142, an OS Operating System 144, a file 148, and the program 146 for controlling the file 148.

The processor 142 analyzes the sales information stored in the information storage means 120 according to the program 146 to generate first coupon information to which an irregular discount range for each time section is applied within a range of a basic discount range, and transmits the first coupon information to the user terminal 300 through the communication means 110. In addition, when the jackpot discount range is extracted at a time when a coupon change request signal is received, the processor 142 generates second coupon information to which a jackpot discount range is applied, and transmits the second coupon information to the user terminal 300 through the communication means 110. In this case, the processor 142 can be configured to output a coupon to which the jackpot discount range is applied only for a designated time according to the program 146.

In addition, when there is a request of transmitting the sales information of a product and a service from the user terminal 300, the host unit 140 searches for the information storage means 120 in which sales information of a product and a service is stored, extracts the corresponding sales information, and transmits the corresponding sales information to the user terminal 300 through the communication means 110.

Referring to FIG. 1, the payment system according to the present invention includes the user terminal 300.

The user terminal 300 is connected to the web server 100 through a web page, receives sales information of a product and a service, and transmits a coupon change request signal to the web server 100 when a touch signal of a coupon change menu of the web page is inputted. When the first coupon information is received from the web server 100, the user terminal 100 outputs the coupon change request signal.

In this case, a coupon providing a coupon change menu of the web page may be any one of selling price, transaction commission, bank remittance commission, parking cost, parking time, point, reward, mileage, virtual currency, currency, and gift certificate. In this case, the transaction commission means a commission imposed on a transaction that exchanges a desired product, such as stocks and the like.

The coupon providing the coupon change menu can be used in an internet shopping mall, a mobile shopping mall, an application, a TV home shopping, a stock trading website, an internet banking website, a parking management website, a travel ticket website, a concert ticket website, an airline ticket website, a virtual currency website, a gift certificate website, a game website, a point website, a reward website, a mileage website, a food delivery website, an accommodation website, an insurance website, a legal service website, a blockchain website, a shopping mall website, and the like.

In addition, the coupon change request signal can be configured as a request signal inputted through any one of electronic money payment, free participation, and advertisement viewing.

More specifically, the user terminal 300 is configured to receive sales information of a product and a service to display the sales information. The sales information of the product and the service may include elements for selecting a purchase of a product and a service, such as purchase, reservation, and coupon, product and service information such as a product name, a service name, a photo of a product, a feature of a product, a seller name, a remaining sale quantity, and the like.

In addition, the user terminal 300 receives a web page from the web server 100 connected through the network 200 as shown in FIGS. 2 and 3, and outputs the web page on a screen. The user terminal 300 receives a touch input of a menu corresponding to electronic money payment, free participation, and advertisement viewing from the user to change the discount range of the coupon through the web page, and transmits a coupon change request signal through the corresponding menu.

For example, when the user terminal 300 transmits a coupon change request signal to the web server 100 through electronic money payment, the user terminal 300 receives first coupon information or second coupon information within a few seconds, within about 1 second, from the web server 100, and outputs a coupon in a screen, which a discount range is changed.

When the user terminal 300 transmits a coupon change request signal to the web server 100 through the advertisement viewing, the user terminal 300 receives and outputs an advertisement video with 15-20 seconds from the web server 100, and then receives and outputs first coupon information or second coupon information from the web server 100, which a discount range is changed.

In addition, when the user terminal 300 transmits a coupon change request signal to the web server 100 through free participation, the user terminal 300 receives and outputs countdown information, which run for twice as long as the advertisement video, for example, 30 seconds of countdown information, from the web server 100, and then receives and outputs first coupon information or second coupon information from the web server 100, which a discount range is changed.

Meanwhile, when the user terminal 300 connects to the affiliate website, which is affiliated with the web page provided by the web server 100, the user terminal 300 is provided with a pop-up window from a server of the affiliate website.

In addition, when a touch signal of the pop-up window is inputted by a user, the user terminal 300 connects to a login page through a hyperlink set in the pop-up window.

Furthermore, when authentication information, which is suitable for the login page, is inputted by a user, the user terminal 300 transmits the authentication information to the web server 100 through the login page.

As such, the user terminal 300 means a means capable of connecting to the web server 100 providing an electronic commerce service through a communication network such as a wireless communication network including a plurality of base stations, base station controllers, mobile communication exchangers, and a WAP gateways, and the like. In this case, a wireless user terminal 300 may be a smartphone, a tablet PC, a laptop computer, or the like, and a wired user terminal 300 may be a personal computer, a communication terminal, a television, a wired telephone, and the like, which have an internet connection means.

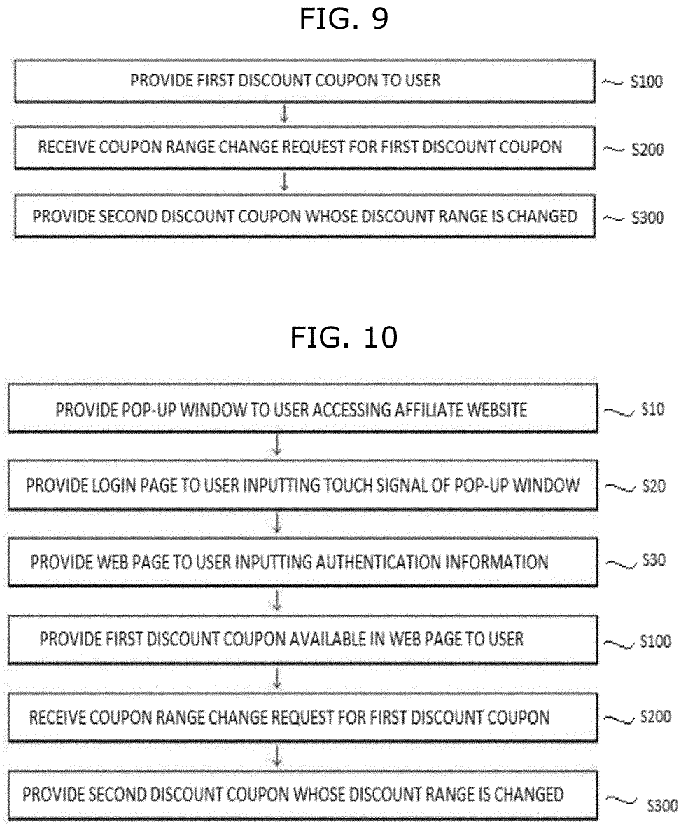

FIG. 9 is a flowchart illustrating a payment method using a discount coupon according to an embodiment of the present invention.

Referring to FIG. 9, a payment method using a discount coupon capable of changing a discount range according to the present invention comprises: a first discount coupon providing step S100 of providing a first discount coupon in which a basic discount range is set and a coupon change menu is included, to a user who connects to a web page; a change request receiving step S200 of receiving a coupon change request signal for the first discount coupon from the user; and a second discount coupon providing step S300 of generating a second discount coupon according to the coupon change request signal and providing the second discount coupon to the user.

More specifically, in the first discount coupon providing step S100, the web server 100 provides a first discount coupon in which a basic discount range is set and a coupon change menu is included, to the user terminal 300 accessing a web page of the web server 100.

If necessary, in the first discount coupon providing step S100, the web server 100 can provide one or more of first discount coupons in which a coupon use website and a basic discount range are set and a coupon change menu is included, to the user terminal 300 connected to the web page.

In addition, in the change request receiving step S200, a web server 100 receives and accepts a coupon change request signal transmitted from the user terminal 300.

Furthermore, the second discount coupon providing step S200 generates a second discount coupon whose discount range is changed according to the coupon change request signal received by the web server 100, and provides the second discount coupon to the user terminal 300. In this case, the user terminal 300 receiving the second discount coupon outputs the received second discount coupon through a screen.

In the second discount coupon providing step S200, the web server 100 generates a second discount coupon whose discount range is changed according to the coupon change request signal received by the web server 100, provides the second discount coupon to the user terminal 300, and transmits generation information of the second discount coupon to a server of the coupon use website so that the second discount coupon can be used in the coupon use website. This process is to register the information of the second discount coupon in the coupon use website so that the second discount coupon can be used in the coupon use website.

FIG. 10 is a flowchart illustrating a payment method using a discount coupon according to another embodiment of the present invention. Referring to FIG. 10, the payment method according to the present invention may further include an advertisement step S10, an authentication step S20, and a link step S30 before the first discount coupon providing step S100.

The advertisement step S10 a step of providing a pop-up window to the user terminal 300 connected to an affiliate website affiliated to the web page provided by the web server 100. The pop-up window is provided to a user terminal 300 in a server providing the affiliate website.

The authentication step S20 is a step of providing a login page to the user terminal 300 when a touch signal of the pop-up window is inputted from the user terminal 300. In this case, advertisement for the discount coupon provided by the web server 100 is exposed in the affiliate website so that the customer can access the web server 100 through the affiliate website.

More specifically, when a touch signal of the pop-up window is inputted, a server providing the pop-up website provides a login page to the user terminal 300 through a hyperlink set in the pop-up window.

The link step S30 is a step that when the authentication information is received through the login page, the web server 100 provides a web page to the user terminal 300. The web server 100 collects authentication information from a customer who is registered as a member to perform a login process. Meanwhile, the web server 100 collects registration information and authentication information from a customer who is not registered as a member and then perform a login process.

Although the present invention has been described with reference to the preferred embodiment of the present invention, it will be understood by one skilled in the art that various modifications and variations can be made without departing from the spirit and scope of the present invention in the appended claims.

What is claimed is:

1. A payment system using a discount coupon that can change a discount range, the payment system comprising:
a web server generating first coupon information whose discount range is changed upon a coupon change request signal received through a web page, and transmitting the first coupon information through the web page; and
a plurality of user terminals transmitting the coupon change request signal to the web server when a touch signal of a coupon change menu of the web page is inputted, and receiving and outputting the first coupon information.

2. The payment system of claim 1, wherein the first coupon information is maintained for a predetermined time.

3. The payment system of claim 1, wherein the discount range for the first discount coupon is determined by a random discount range which is irregularly selected within a predetermined discount range.

4. The payment system of claim 3, wherein the web server analyzes an electronic commerce profit rate based on transaction information of sold products, extracts a jackpot discount range exceeding the predetermined discount range if the profit rate exceeds a predetermined profit rate, generates second coupon information whose discount range is changed to the jackpot discount range, and transmits the second coupon information to the user terminal through the web page.

5. The payment system of claim 3, wherein the web server analyzes accumulated profits of electronic money used to generate the coupon change request signal as the coupon change request signal is received, extracts a jackpot discount range exceeding a predetermined discount range if the accumulated profits exceed a predetermined profit, generates second coupon information whose discount range is changed to the jackpot discount range, and transmits the second coupon information to the user terminal, which has transmitted the coupon change request signal, through the web page.

6. The payment system according to claim 3, wherein the web server analyzes an accumulated sale quantity based on transaction information of sold products, extracts a jackpot discount range exceeding a first designated discount range when a first coupon change request signal is received after a predetermined sale quantity is sold, generates second coupon information whose discount range is changed to the jackpot discount range, and transmits the second coupon information to the user terminal, which has transmitted the first coupon change request signal, through the web page.

7. The payment system of claim 1, wherein the coupon change request signal is a request signal inputted through any one of money payment, point payment, reward payment, mileage payment, gift certificate payment, virtual currency payment, free participation, and advertisement viewing.

8. The payment system of claim 1, wherein when the web server receives the coupon change request signal including a change of a payment means to a virtual currency to virtual currency, the web server changes a selling price of a product included in sales information into a virtual currency unit, generates first coupon information changed in a unit of virtual currency, and transmits the first coupon information to the user terminal, which has transmitted the coupon change request signal, through the web page.

9. The payment system of claim 1, wherein the discount range is any one of a discount rate, a discount amount of money, and a discount time.

10. The payment system of claim 9, wherein the discount rate and the discount amount are applied in any one of currency, virtual currency, membership point, reward, mileage, and gift certificate.

11. The payment system of claim 1, wherein the coupon providing a coupon change menu of the web page is any one of coupons of selling price of a product, transaction commission, bank remittance commission, parking cost, parking time, point, reward, mileage, virtual currency, currency, and gift certificate.

12. A payment method using a discount coupon that can change a discount range, the payment method comprising:
a first discount coupon providing step of providing, by a web server, a first discount coupon in which a basic discount range is set and a coupon change menu is included, to a user terminal accessing a web page;
a change request receiving step of receiving, by the web server, a coupon change request signal generated through the coupon change menu; and
a second discount coupon providing step of generating, by the web server, a second discount coupon whose discount range is changed according to the coupon change request signal, and providing the second discount coupon to the user terminal.

13. The payment method of claim 12, before the first discount coupon providing step, the payment method further comprising:
an advertisement step of providing a pop-up window to the user terminal accessing a website affiliated with the web page;
an authentication step of providing a login page to the user terminal through a hyperlink set in the pop-up window when a touch signal of the pop-up window is inputted; and
a link step of providing, by the web server, the web page to the user terminal when authentication information is received through the login page.

14. The payment method according to claim 12, wherein first discount coupon providing step is a step that the web server provides one or more of the first discount coupons in which a coupon use website and a basic discount range are set and a coupon change menu is included, to the user terminal accessing the web page;
wherein the second discount coupon providing step includes steps of:
generating the second discount coupon whose discount range is changed according to the coupon change request signal received by the web server,
providing the second discount coupon to the user terminal, and
transmitting generation information of the second discount coupon to a server of the coupon use website so that the second discount coupon can be used in the coupon use website.
